(19) United States
(12) Patent Application Publication
(10) Pub. No.: US 2008/0075594 A1
(43) Pub. Date: Mar. 27, 2008

(54) Self-regulating windmill with horizontally oriented blades

(76) Inventors: James L. Bailey, East Helena, MT (US); Nelson Buck, East Helena, MT (US)

Correspondence Address: TRASK BRITT, P.O. BOX 2550, SALT LAKE CITY, UT, 84110, US

(21) Appl. No.: 11/901,134

(22) Filed: Sep. 14, 2007

Related U.S. Application Data
(60) Provisional application No. 60/844,864, filed on Sep. 15, 2006.
(60) Provisional application No. 60/844,738, filed on Sep. 15, 2006.

(51) Int. Cl. F03D 7/06

(52) U.S. Cl. 416/104

(57) ABSTRACT

A windmill having horizontally oriented blades with inherent rotational velocity is disclosed. Clam-shaped individual vanes having a straight edge are longitudinally aligned to operate as a pair of vanes which open or close, depending on wind velocity, to provide a rotational velocity within certain desirable limits.

### CROSS-REFERENCE TO RELATED APPLICATIONS

This application claims priority to U.S. provisional application No. 60/844,864 filed Sep. 15, 2006 and to U.S. provisional application No. 60/844,738 filed Sep. 15, 2006, the contents of the entirety of each of which are incorporated herein by this reference.

### BACKGROUND OF THE INVENTION

1. Field of the Invention

Windmills have historically been used for numerous purposes and have ancient origins.

2. State of the Art

Recent increased interest in supplanting hydrocarbon fueled electrical power generating plants has focused on wind power. Wind farms utilizing large propeller-type windmills exist in various parts of the United States and elsewhere.

The large propeller-type windmills have certain disadvantages, e.g., very tall towers must be built to accommodate propellers with blades of 50 feet and greater in length. Because the propeller rotates about a horizontal axle, a gear-box must be located at the top of the tower to translate the mechanical force from the propeller axle to a vertical driveshaft. Extra weight, in addition to the weight of the propeller, at the top of a tall tower is generally undesirable. Furthermore, propeller-type windmills must generally be shut down during periods of extra-high winds, such as during storms.

Windmills with horizontally oriented blades have been illustrated and described in certain existing patents. For example, U.S. Pat. No. 5,083,902 to Rhodes illustrates one type of windmill with horizontally oriented blades, which, in the described structure, are made of fabric.

The Rhodes' structure employs a movable weight on the arms of the windmill which slide outward and inward to control rotational speed of the vanes by causing the vanes to expose more or less effective vane area to the wind.

Other horizontally oriented windmills are illustrated and described n U.S. Pat. Nos. 4,474,529 to Kinsey and 6,270,308 to Grappel. These devices have fixed vanes and have turbine-type rotating members with a partial enclosure including the rotating members.

U.S. Pat. No. 5,823,749 to Green utilizes a two-phase sail system. The sails are made of a fabric; one sail is a scoop and the other a wing.

### BRIEF SUMMARY OF THE INVENTION

A windmill with horizontally rotating blades which adjust their angle to present smaller or larger wind-impacting areas is disclosed.

The blades typically comprise a pair of elongated vanes hinged together along an extended, substantially straight edge of each vane. A plurality of blades extend radially from a vertical driveshaft. The blades are constructed to open during substantially one-half revolution to be driven by the wind in their open condition and to close during the remainder of a revolution when the blades are cutting against the wind.

The invention further involves an automatic control system which opens the vanes to a desired degree depending upon wind velocity to control rotational speed, especially in very strong winds which would require traditional propeller-type windmills to be shut down. The ability of the windmills of the instant invention to operate efficiently at very low and very high velocities is a particular advantage of the instant invention in comparison to other types of windmills.

The number of blades radiating from the driveshaft is usually in multiples of two or three. The blades may radiate perpendicularly to the driveshaft or at a slight angle to the perpendicular with alternate blades being angled up or down to prevent a “wind shadow” from one blade being cast on a preceding blade when the blades are traveling in the direction of the wind.

Individual vanes generally are elongated members with at least one substantially elongated straight edge. The vanes are laterally curved so that a pair of blades, when in an open condition, present a trough-like surface to be impacted by the wind. During rotation into the wind, the folded blades present a curved, aerodynamic surface to cut through the wind with minimal resistance

The rotational speed control mechanism in a mechanical embodiment involves weighted pendulums typically in equal number to the number of radiating blades. These are connected either directly or indirectly to the driveshaft so that as rotational velocity increases the pendulums swing outward, which through mechanical arm connectors to the vanes cause the hinged blades to close towards one another, thus reducing the wind impact area of a blade, thus maintaining rotational velocity. This interaction of the weighted pendulums and adjustable wind impact area of a blade tends to maintain a substantially constant rotational velocity.

The size of the wind-impact area of a blade and the length of moment arm of a weighted pendulum are preferably balanced so that an equilibrium is substantially maintained. For example, if the momentum arm and weight of the individual pendulums are too great even at high rotational velocities the pendulums may not swing outward to a sufficient degree to decrease the wind-impact area of a blade. Furthermore, from a structural standpoint, since the weighted pendulums are typically near the location of the radiating blades it is generally desirable to have the least weight possible at the top of the tower supporting the windmill.

The horizontally oriented windmills of the instant invention have numerous advantages over the vertically-oriented, conventional-propeller windmills.

Horizontally oriented blade or vanes may be “stacked” on a single tower without interfering with or blocking one another. Further, rotation about a vertical axis provides a minimal vertical profile. In contrast a horizontally rotating propeller sweeps a large vertical area, which is very hazardous to birds and bats.

A blade sweeping a vertical plane slices traversely to a bird's or bat's flight path. A horizontally rotating blade is running with the wind on one half of its rotation and would be moving under many situations at the same approximate speed as a bird or bat while blades rotating into the wind are closed and have a generally airfoil shape so that birds and bats would tend to be lifted over the blade.

The versatility of the instant invention is illustrated by the construction of structures which have stacked rotors, structures which have a telescoping shaft (axle) so that the rotor height above the ground can be adjusted vertically to place the rotor in the highest velocity wind stream.

A further advantageous structure is one where the blades or vanes of a rotor do not extend in the same horizontal plane but alternately extend at an upward angle and downward angle so that the sail area of one blade is not blocked by the wind and shadow of an adjacent blade.

The clam shape and action of the blades to open wide on the power-generation one-half turn (approximately 180° arc) while closing to form a minimal-resistance airfoil during the one-half rotation into the wind is very advantageous and efficient in translating wind energy into mechanical energy (rotation of vertical driveshaft) and ultimately into electrical energy, if desired, via a generator connected to the lower end of the vertical driveshaft.

In the event of disastrous weather conditions, e.g., hurricane force winds, or very severe ice storms, the blades of a rotor may be constructed to fold down against the tower to be secured there.

Windmills of the instant invention may have stacked sets of blades at different locations along the vertical driveshaft. Additionally, the driveshaft and tower may be vertically adjustable to place the horizontally oriented blades at a preferred distance above the ground where maximum wind velocities are occurring.

A rotational velocity control mechanism is preferably associated with each set of horizontally oriented blades located at different vertical distances along the driveshaft.

The rotational velocity control mechanism preferably matches the length of pendulum arms, weight at the end of each arm and the sail area of a blade (open pair of vanes) correlated to take maximum advantage of the average wind velocities expected to be encountered for a given site location.

If the open blade sail area is too great for a given rotational velocity control mechanism, e.g., pendulum arms too short and pendulum weights too small, the control mechanisms will be unable to provide enough closing force to close partially a pair of hinged vanes to reduce the available sail area of a blade during high wind speeds.

Having the pendulums of the control mechanism located along the vertical axis of the windmill is preferable to having sliding weights on the radial arms supporting the blades. The radial arms of the instant windmill do not have to be as heavy and structurally large when the control pendulums are adjacent the driveshaft.

A useful alternative to a direct mechanical drive train between the windmill driveshaft and an electric generator, for example, is to utilize a hydraulic pump to translate power from the rotating blades to some machine, such as an electric generator, water pump or the like.

A hydraulic pump could be located at the top of the tower with a hydraulic line (conduit connecting the pump to electric motors or the like located at the bottom of the windmill tower. Preferably, the hydraulic motor is located at the bottom of the tower intermediate the elongated driveshaft and an electric motor for example. The hydraulic pump from several windmills may be joined together (ganged) to drive a single large electric motor, pump or the like.

A further feature which may be advantageously employed through the use of one or more hydraulic pumps is one or more hydraulic fluid standpipes which are preferably sufficiently tall to provide sufficient hydraulic fluid head (pressure) to propel an electric motor having a hydraulic drive unit attached to it whenever the wind velocity was insufficient during a brief lull to propel the hydraulic pump to a proper speed to generate minimal hydraulic fluid pressure at the hydraulic pump discharge. A hydraulic standpipe is attached to the discharge of one or more hydraulic pumps and “rides” on the pump discharge conduit.

The hydraulic standpipe may be associated with proper valving to allow the standpipe fluid to drain through a hydraulic drive unit to a sump located at a lower level than the hydraulic drive unit to take full advantage of the hydraulic head in the standpipe. When the windmill blades rotate again at minimal power producing speed in an auxiliary pump may be engaged to pump the hydraulic fluid from the sump into the intake of the hydraulic pump connected to the windmill driveshaft, thus retaining the hydraulic fluid to the circulating system to fill up the standpipe again.

Other techniques and systems may, of course, be employed to provide power to maintain a constant output from an electric generator during brief lulls in wind velocity. Any system for storing energy, especially as potential energy, with the facility to convert it to sufficient kinetic energy may be employed. Electrical energy storage devices such as batteries, banks of condensers, etc. may be used as well as mechanical devices, such as large fly wheels, etc.

Generally, windmill sites are chosen based upon a survey of predictable constant winds. And, since the windmills of the instant invention are efficient at low and high velocities the likelihood of extended periods of ineffectiveness is minimal.

### BRIEF DESCRIPTION OF THE SEVERAL VIEWS OF THE DRAWINGS

In the drawings, which illustrate what is currently considered to be the best mode for carrying out the invention:

FIG. 1 is an illustration to show the WindCatcher unit in relation to the supporting tower, generator room, drive shaft, rotor, an opened cup blade, a closed returning blade and the directional value;

FIG. 2 is an illustration of the rpm regulation components;

FIG. 3 is another view of FIG. 2;

FIG. 4 is another view of FIG. 2;

FIG. 5 is a view of the functional components of the open/close blade assembly;

FIG. 6 is a closed view of the blade assembly;

FIG. 7 is another view of FIG. 6;

FIG. 8 is a partially opened blade;

FIG. 9 is a view of the support arm and rotor;

FIG. 10 is another view of FIG. 9;

FIG. 11 is another view of FIG. 9;

FIG. 12 is another view of FIG. 5;

FIG. 13 is another view of FIG. 5;

FIG. 14 is a full view of FIG. 9 the support arms;

FIG. 15 is another view of FIG. 14;

FIG. 16 is a view of the hinge assembly for the blade opening/closing mechanism;

FIG. 17 is a view of the rotor assembly including the rpm speed weights and directional vane;

FIG. 18 is the view of the control plate in the rotor; and

FIG. 19 is the bottom rotor plate.

### DETAILED DESCRIPTION OF THE INVENTION

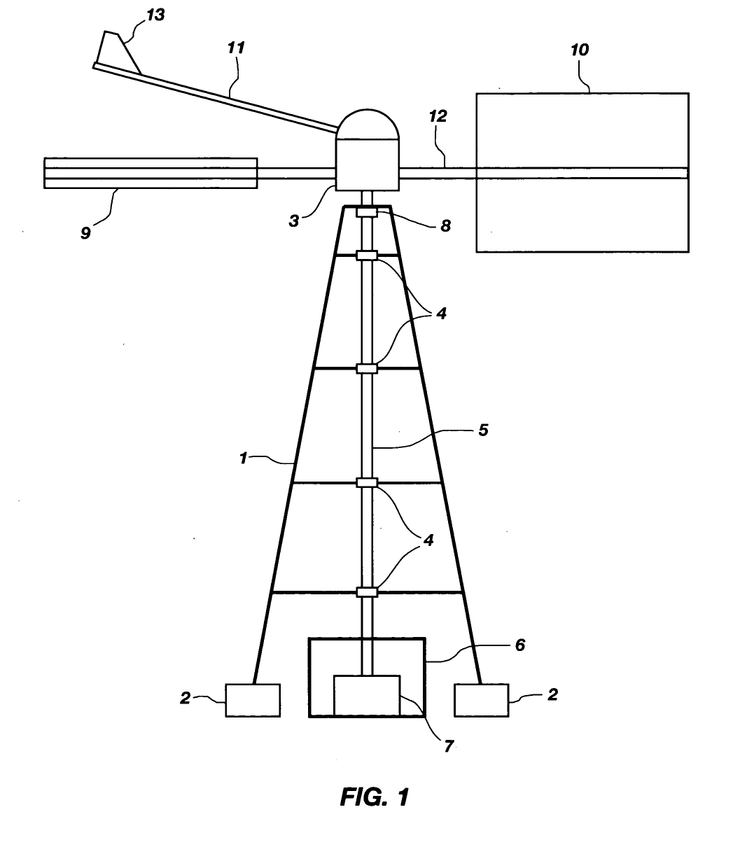

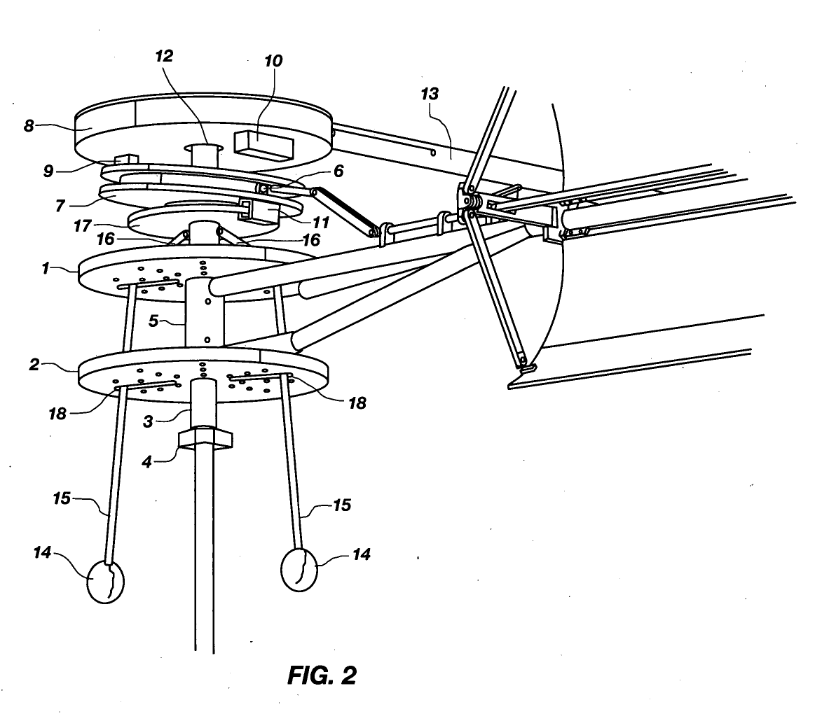

A support tower framework (FIG. 1-1) mounted at the base to the ground (FIG. 1-2) and extending upward connecting to the rotor section (FIG. 1-3) also containing numerous support positions holding bearings (FIG. 1-4), which contain numerous sections of driveshaft (FIG. 1-5) to transfer torque from the rotor section to the ground section. The ground section encompassing the driveshaft section contains a housing (FIG. 1-6) in which a generator or other gearing mechanics (FIG. 1-7) are connected to the driveshaft to utilize the torque produced by the turning driveshaft reside.

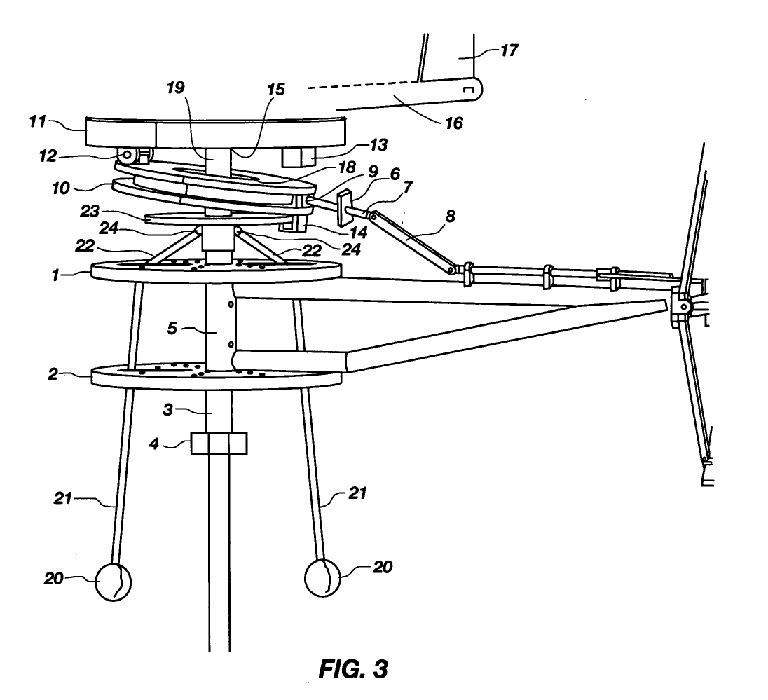

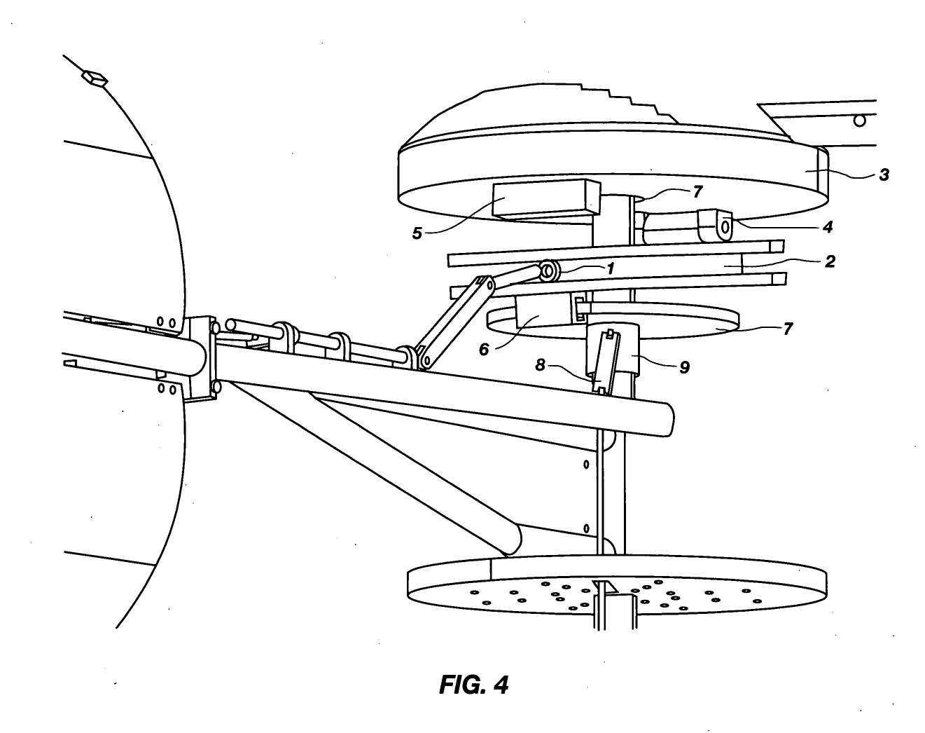

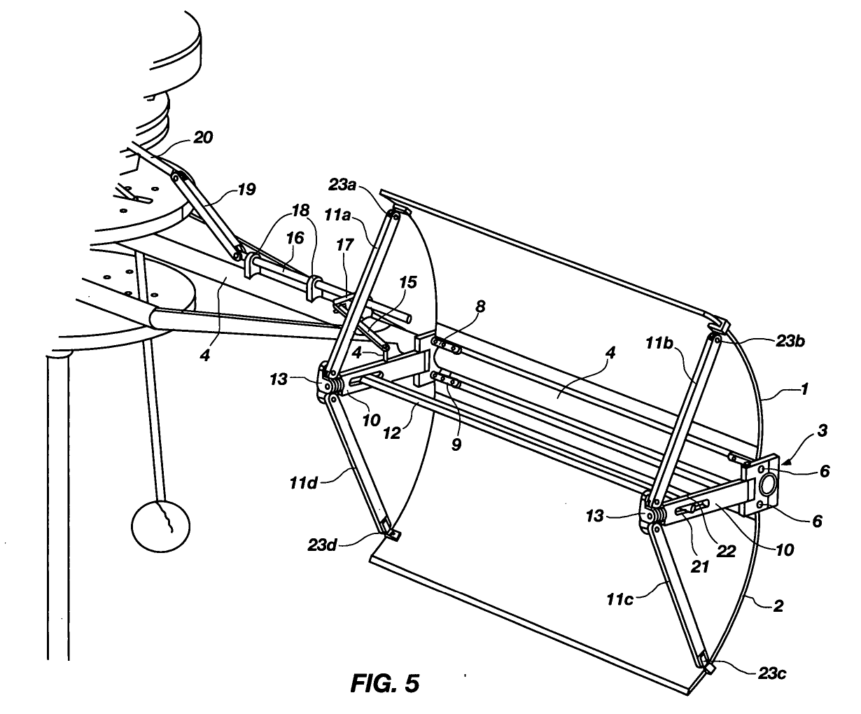

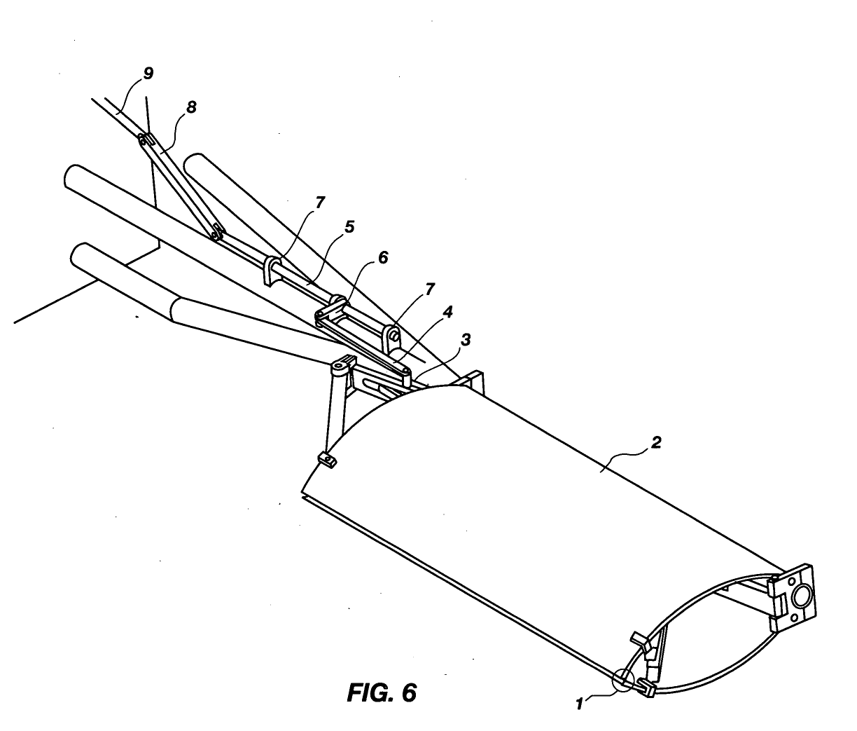

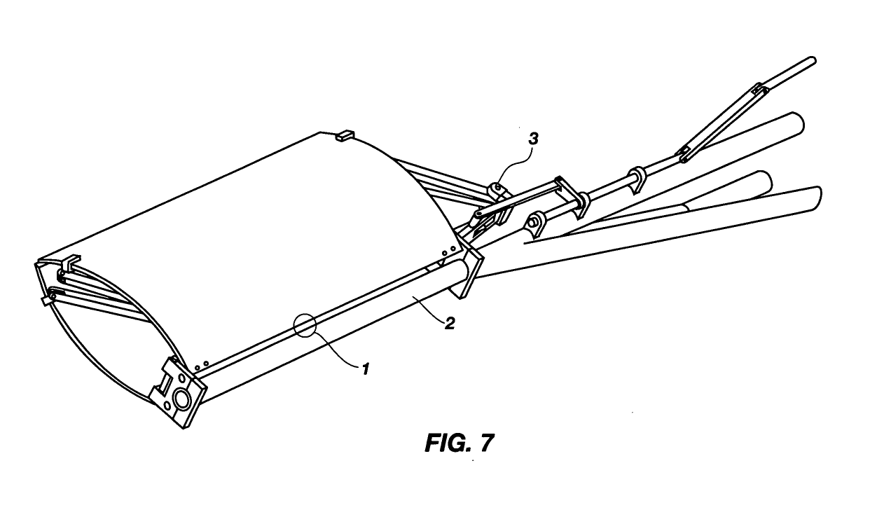

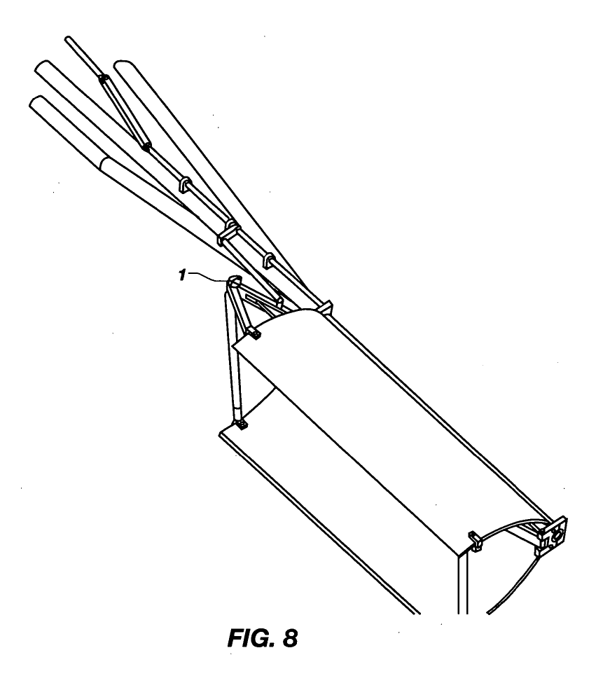

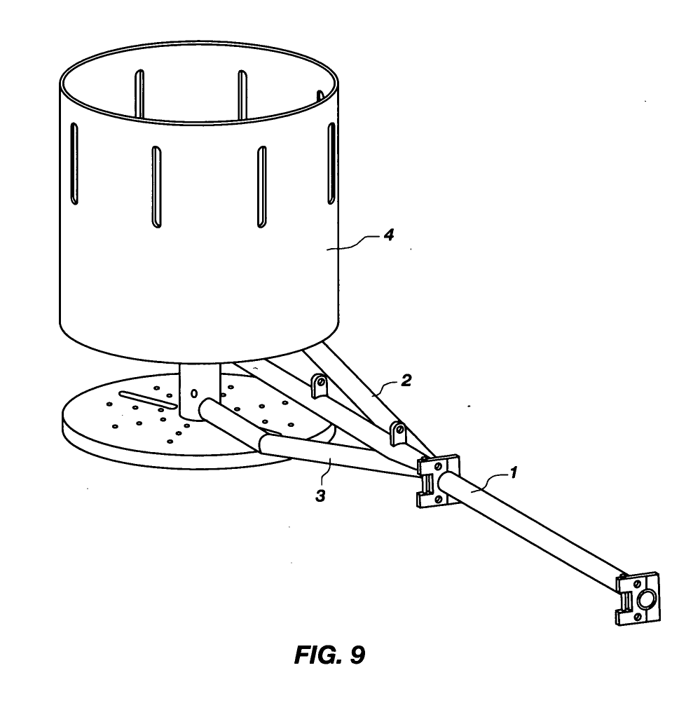

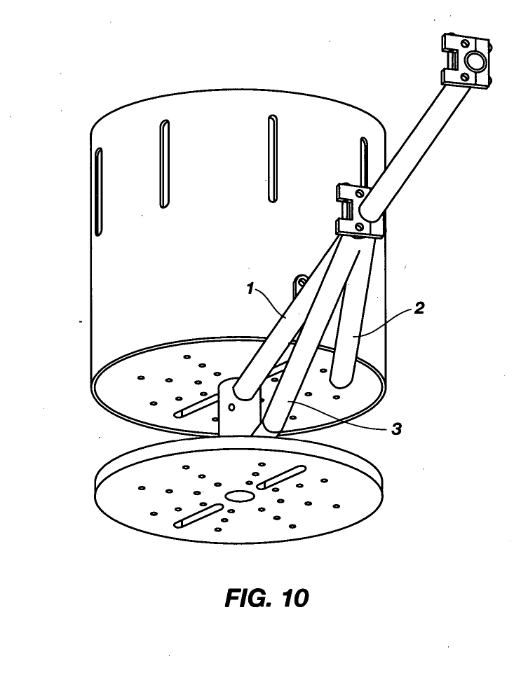

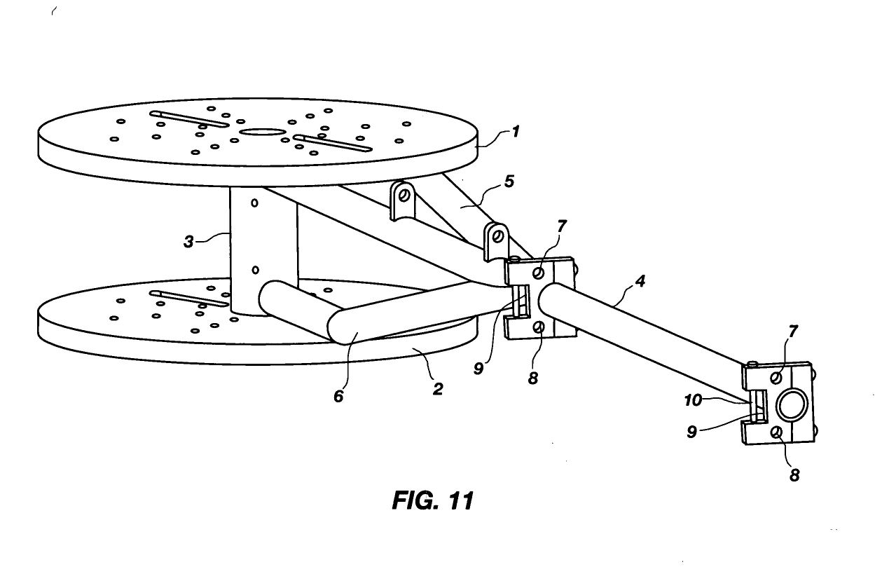

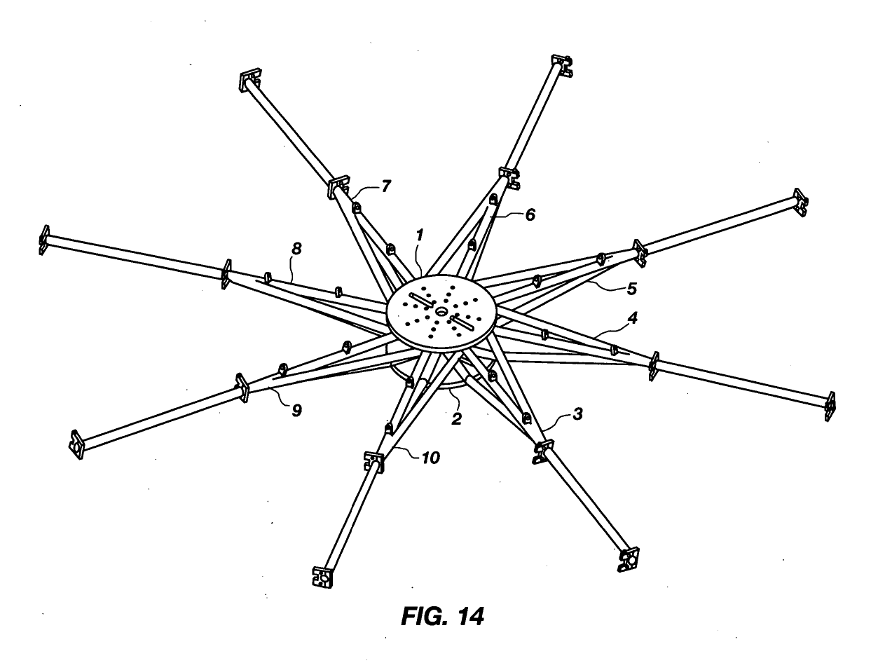

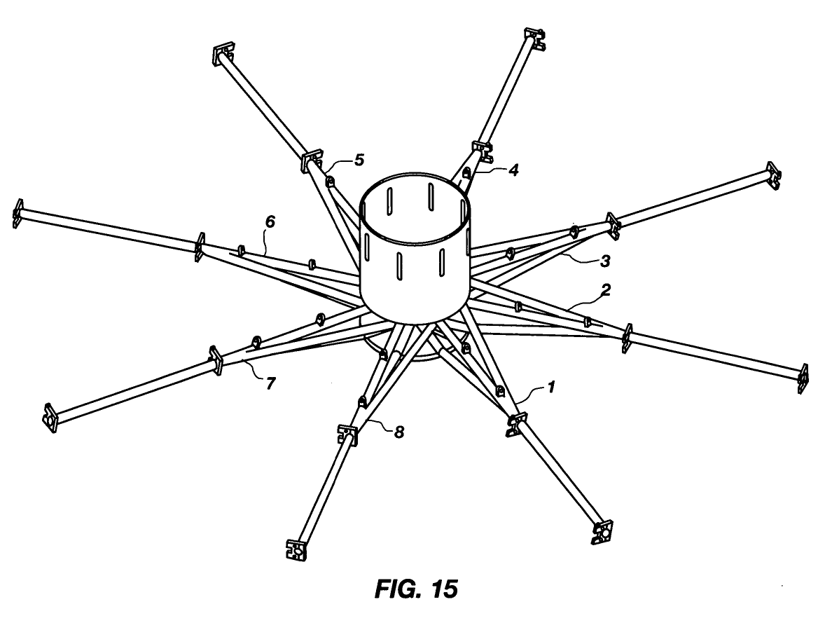

The rotor section (FIG. 2, FIG. 3, FIG. 4) includes two disks (FIG. 2-1, FIG. 2-2, FIG. 3-1, FIG. 3-2, FIG. 11-1, FIG. 11-2, FIG. 14-1, FIG. 14-2) attached firmly to the driveshaft upper section (FIG. 1-8, FIG. 2-3, FIG. 3-3) and supported by a bearing attached to the up most part of the support tower framework section (FIG. 1-8, FIG. 2-4, FIG. 3-4). These two disks (FIG. 2-1, FIG. 2-2, FIG. 3-1, FIG. 3-2, FIG. 11-1, FIG. 11-2, FIG. 14-1, FIG. 14-2) are mounted in parallel and have an axle to separate them (FIG. 2-5, FIG. 3-5, FIG. 11-3). Also attached between these two disks is an array of eight framework arms (FIG. 14-3, FIG. 14-4, FIG. 14-5, FIG. 14-6, FIG. 14-7, FIG. 14-8, FIG. 14-9, FIG. 14-10, FIG. 15-1, FIG. 15-2, FIG. 15-3, FIG. 15-4, FIG. 15-5, FIG. 15-6, FIG. 15-7, FIG. 15-8) to support the cupped flap sections.

The support framework arms are comprised of three different lengths of tubes to form a triangle (FIG. 9-1. FIG. 9-2, FIG. 9-3, FIG. 10-1, FIG. 10-2, FIG. 10-3, FIG. 11-4. FIG. 11-5, FIG. 11-6) with two tubes (FIG. 9-1, FIG. 9-2, FIG. 10-1, FIG. 10-2, FIG. 11-4. FIG. 11-5) attached to the upper disk (FIG. 2-1, FIG. 3-1, FIG. 11-1) and one tube attached to the lower disk (FIG. 2-2, FIG. 3-2, FIG. 11-2). The lower tube (FIG. 9-3, FIG. 10-3, FIG. 11-6) being the shortest tube is inline vertically and connected at mid point with the longest tube (FIG. 9-1, FIG. 10-1, FIG. 11-4) on the top disk and the third tube (FIG. 9-2, FIG. 10-2, FIG. 11-5) to connect from this point to the top disk at the point where the next support framework arm longest tube extends from the same top disk thereby giving the longest tube rotational torque support as well as upward support for the cupped flap sections (FIG. 1-9, FIG. 1-10).

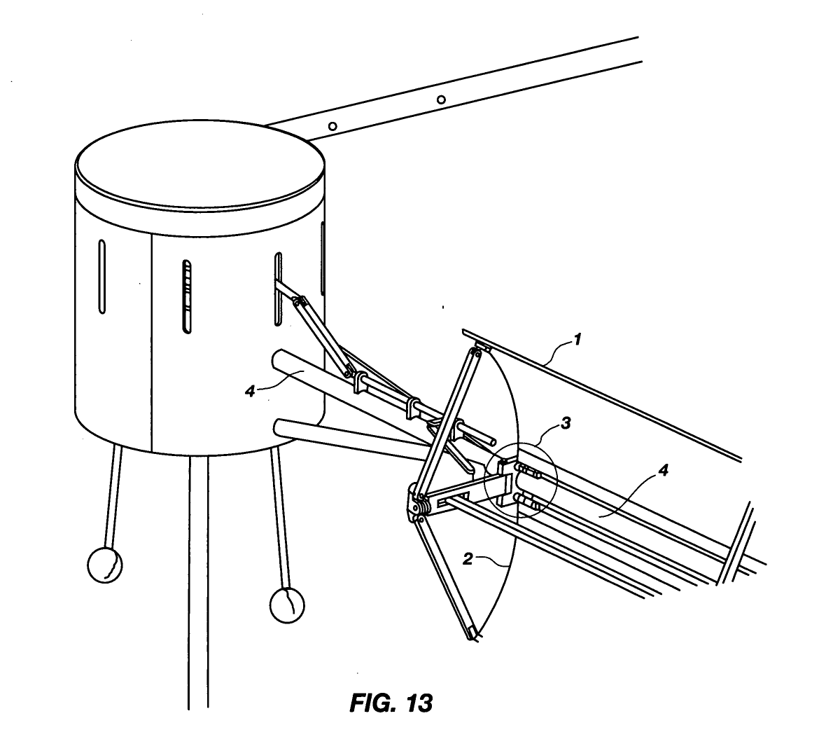

There are eight cupped flap or vane sections attached to these support framework arms (FIG. 14-3, FIG. 14-4, FIG. 14-5, FIG. 14-6, FIG. 14-7, FIG. 14-8, FIG. 14-9, FIG. 14-10, FIG. 15-1, FIG. 15-2, FIG. 15-3, FIG. 15-4, FIG. 15-5, FIG. 15-6, FIG. 15-7, FIG. 15-8). The cupped flap sections (FIG. 1-9, FIG. 1-10) are comprised of two rectangular flaps (FIG. 5-1, FIG. 5-2, FIG. 13-1, FIG. 13-2) that are curved to achieve a cupped form and a flap support connection assembly (FIG. 5-3, FIG. 13-3) and also a flap actuating assembly (FIG. 5). There is an upper cupped flap (FIG. 5-1, FIG. 13-1) extending up from the longest support tube (FIG. 5-4, FIG. 13-4) and a lower cupped flap (FIG. 5-2, FIG. 13-2) extending below the longest support tube both of which connect to the tube using the flap support connection assembly (FIG. 5-3, FIG. 13-3) and when in the open configuration (FIG. 5) will form a large cup comprised of the two rectangular cupped flaps.

In the closed configuration (FIG. 6, FIG. 7) the two cupped vanes will come together so that the concave surfaces of the two cups (FIG. 6-1) are facing each other and the edge connected to the longest support tube (FIG. 6-2, FIG. 7-1) of both cups is horizontally parallel to the opposite edges of each cupped vane. This closed configuration forms a wing (airfoil) that will have the same wind resistance coming from the connecting edge (FIG. 7-1) of the flaps connected to the longest support tube (FIG. 7-2) as it has coming from the outside edges of the two flaps in front of the support tube (FIG. 6-1). The closed configuration of the vanes has very minimal wind resistance as opposed to the open configuration (FIG. 5) forming a large sail area of a general concave shape which has high wind resistance.

The vane support connection assembly (FIG. 5-3) is comprised of two tube clamps one connected to the longest support tube just past the connection of the three support tubes attachment point (FIG. 5-5) and the other tube clamp connected to the longest support tube at the end of the tube farthest from the two support disks (FIG. 5-3). The tube clamps have two pin holes (FIG. 11-7, FIG. 11-8) parallel to the support tube (FIG. 11-4) and equally spaced above (FIG. 11-7) and below (FIG. 11-8) the support tube and also in front of the support tube as to connect to the base portion of the upper (FIG. 5-6) and lower (FIG. 5-7) flaps.

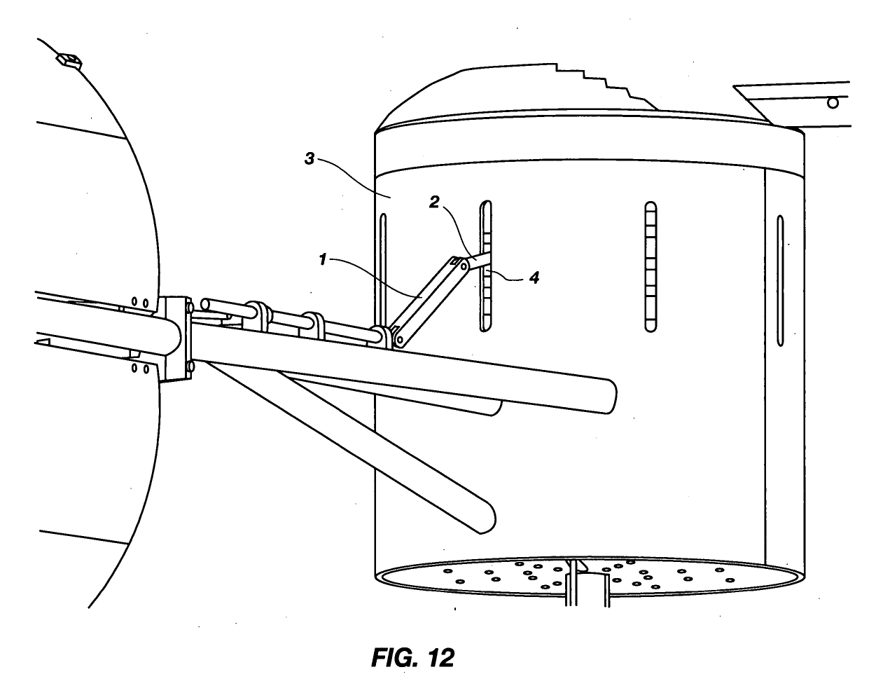

Pins inserted in these holes (FIG. 5-8, FIG. 5-9) of the tube clamps are connected to the base sections of the vanes as to achieve a hinge mechanism to allow the two vanes to open and close freely. The tube clamps also have a “u” shaped slot (FIG. 11-9) in front of the two pin holes with another pin (FIG. 11-10) perpendicular to the longest support tube running thru the end of the “u” shape slot to attach to the vane actuating assembly (FIG. 5). The vane actuating assembly is comprised of two support swing arms (FIG. 5-10), four flap support arms (FIG. 5-11), a swing arm connecting rod (FIG. 5-12), two flap arm hinges (FIG. 5-13), an outer actuating arm pin (FIG. 5-14, FIG. 6-3), an outer actuating arm (FIG. 5-15, FIG. 6-4), a pushrod (FIG. 5-16, FIG. 6-5, a pushrod arm (FIG. 5-17, FIG. 6-6), two pushrod bushings (FIG. 5-18, FIG. 6-7), an inner actuating arm (FIG. 3-8, FIG. 5-19, FIG. 6-8, FIG. 12-1), a sliding rod (FIG. 3-7, FIG. 5-20, FIG. 6-9, FIG. 12-2), a sliding rod tube (FIG. 9-4, FIG. 12-3), a sliding rod base (FIG. 3-6, FIG. 12-4) and a sliding rod bearing (FIG. 2-6, FIG. 3-9, FIG. 4-1).

The support swing arms (FIG. 5-10) are attached one to each one of the tube clamps (FIG. 5-3, FIG. 5-5) from the base of the support swing arm (FIG. 5-10) to the pin at the “u” shaped slot of the tube clamp (FIG. 11-10) so the swing arm is free to move from being parallel to the longest support tube in front of the cupped section (FIG. 5) of the vanes to being perpendicular to the longest support tube (FIG. 6) in front of the cupped section of the vanes. Midway in the support swing arms is a lengthwise slot (FIG. 5-21) with a pin (FIG. 5-22) perpendicular to the swing arm whereby the swing arm connecting rod (FIG. 5-12) passes thru and requires the two swing arms to move in unison. At the top of each swing arm is bolted a vane arm hinge (FIG. 5-13).

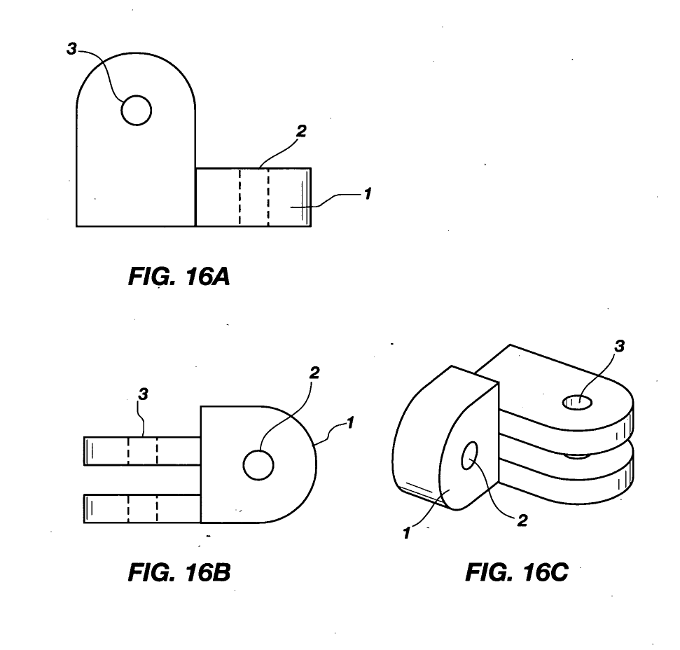

The vane arm hinge is comprised of two sections that hinge on a bolthole (FIG. 16) connected to the top of the swing arm and open and close towards the outer most edge of the swing arm perpendicular to the movement of the swing arm (FIG. 5-10, FIG. 8-1, FIG. 7-3). The two outer edges from the bolthole of the vane arm hinge (FIG. 16-1) have a hole (FIG. 16-2) that is perpendicular to the bolthole (FIG. 16-3) itself and connect to the vane support arms (FIG. 5-11). One flap arm hinge is connected to two vane support arms. One vane support arm being the upper (FIG. 5-11a, FIG. 5-11b) and one being the lower (FIG. 5-11c, FIG. 5-11d). The opposite end of the flap support arms are connected to the edge of the cupped vanes (FIG. 5-23) opposite the base edge where they are connected to the tube clamps with a ball and socket type bearing (FIG. 5-23) as to give a two way motion for twist and swing. One vane support arm (FIG. 5-11a) will be connected to the upper and inward portion of the upper vane (FIG. 5-23a) and one vane support arm (FIG. 5-11b) will be connected to the outer most portion of the upper vane (FIG. 5-23b) and one vane support arm (FIG. 5-11d) will be connected to the lower inward portion of the lower vane (FIG. 5-23d) and one vane support arm (FIG. 5-11c) will be connected to the lower outer most portion of the lower vane (FIG. 5-23c).

About midway on the top edge of the inner support swing arm will be a pin (FIG. 5-14, FIG. 6-3) connecting the swing arm (FIG. 5-10) to the outer actuating arm (FIG. 5-15, FIG. 6-4). The other end of the outer actuating arm (FIG. 5-15, FIG. 6-4) is connected to the pushrod arm (FIG. 5-17, FIG. 6-6) with another pin. The pushrod arm (FIG. 5-17) is parallel to the inner swing arm (FIG. 5-10) when the swing arm is in the open configuration (FIG. 5). The pushrod arm (FIG. 5-17, FIG. 6-6) is connected to the outer end of the pushrod (FIG. 5-16, FIG. 6-5). The pushrod is parallel and on top of the longest support tube (FIG. 5-4) supported by two pushrod bushings (FIG. 5-18, FIG. 6-7) that are mounted on the top of the longest support tube (FIG. 5-4). The pushrod bushings are separated along the longest support tube as to give some linear movement along the support tube but to also maintain parallelism between the support tube and the pushrod. The inner end of the pushrod (FIG. 5-16, FIG. 6-5) is connected to the inner actuating arm (FIG. 5-19, FIG. 6-8) with a pin.

The inner actuating arm (FIG. 5-19, FIG. 6-8) is above the longest support tube (FIG. 5-4) and extends above the pushrod (FIG. 5-16, FIG. 6-5). The inner most end of the inner actuating arm (FIG. 5-19, FIG. 6-8) is connected to the sliding rod (FIG. 5-20, FIG. 6-9) with a pin. The sliding rod (FIG. 5-20, FIG. 6-9, FIG. 12-2) is attached to the sliding rod base (FIG. 12-4, FIG. 3-6) at the mid point of the rod (FIG. 3-7) firmly and has the sliding rod bearing (FIG. 3-9, FIG. 2-6) attached to the inner most end of the sliding rod (FIG. 3-7) with a bolt. The sliding rod bearing (FIG. 3-9) has its axis perpendicular and centered on the sliding rod (FIG. 3-7) itself. The sliding rod base (FIG. 3-6) is a square part with a hole in the center for the sliding rod to attach into and on two edges has “u” shaped slots running up and down to provide a locking mechanism to slide up and down inside a large slot of the sliding rod tube (FIG. 9-4, FIG. 12-3). The sliding rod tube (FIG. 9-4, FIG. 12-3) is a large tube connected firmly to the top disk (FIG. 3-1) of the support tubes and extends upward to cover the sliding rod mechanics.

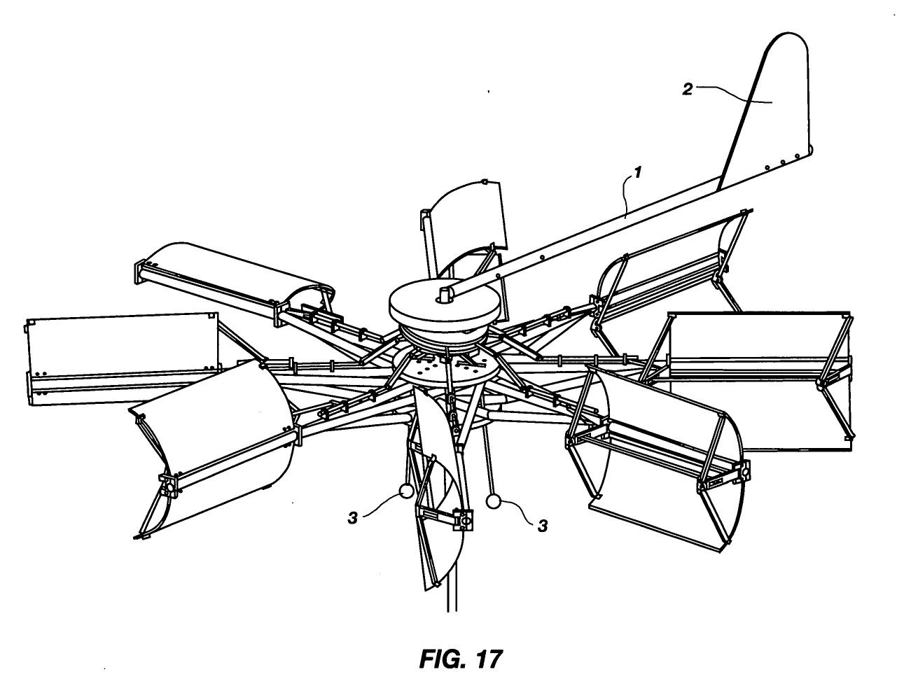

The sliding rod tube has the same inner diameter as the outer diameter of the upper disk. The sliding rod tube (FIG. 9-4, FIG. 12-3) has eight large vertical slots distributed evenly around the diameter and each slot is aligned with the longest support arm tube of the eight support arm assemblies (FIG. 15). The sliding rod bearing (FIG. 3-9) is located vertically by the speed control assembly (FIG. 2, FIG. 3) in the outer groove of the lower control disk (FIG. 2-7, FIG. 3-10, FIG. 4-2). The speed control assembly is comprised of a lower control disk (FIG. 2-7, FIG. 3-10, FIG. 4-2), an upper control disk (FIG. 2-8, FIG. 3-11, FIG. 4-3), a control disk hinge (FIG. 2-9, FIG. 3-12, FIG. 4-4), a control disk stop (FIG. 2-10, FIG. 3-13, FIG. 4-5), a control disk actuator (FIG. 2-11, FIG. 3-14, FIG. 4-6), two control disk bearings (FIG. 2-12, FIG. 3-15, FIG. 4-7), a directional arm (FIG. 1-11, FIG. 2-13, FIG. 3-16, FIG. 17-1) and a directional fin (FIG. 1-13, FIG. 3-17, FIG. 17-2).

The lower control disk (FIG. 2-7, FIG. 3-10, FIG. 4-2) is a disk with a groove in the outside diameter large enough to hold the outer diameter of the sliding rod bearing (FIG. 2-6, FIG. 3-9, FIG. 4-1).

Attached to the top of the lower control disk towards its outside edge is the control disk stop (FIG. 2-10, FIG. 3-13, FIG. 4-5) which is a block that is at the same height as the upper face of the control disk hinge pin (FIG. 2-9, FIG. 3-12, FIG. 4-4) when in the closed position.

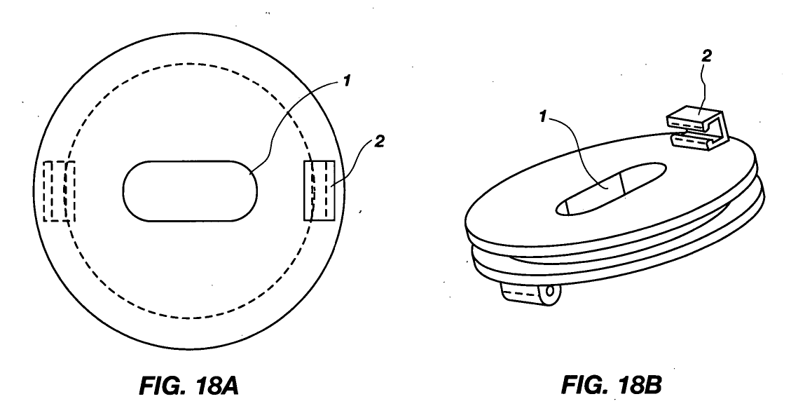

The control disk hinge lower face is attached to the top of the lower control disk (FIG. 2-7, FIG. 3-10, FIG. 4-2) opposite the control disk stop towards the outside edge of the lower control disk diameter (FIG. 3-12). Between the control disk stop (FIG. 2-10, FIG. 3-13, FIG. 4-5) and the control disk hinge (FIG. 2-9, FIG. 3-12, FIG. 4-4) is a large hole (FIG. 3-18, FIG. 18-1) in the lower control disk elongated to accommodate the extension of the axle (FIG. 3-19) from the two disks of the rotor section without touching the axle as the hinge moves the lower control disk downward.

The control disk actuator (FIG. 2-11, FIG. 3-14, FIG. 4-6, FIG. 18-2) is attached to the bottom of the lower control disk just below where the control disk stop is located. The control disk actuator is a block with a “u” shaped slot in the block perpendicular to the axle that runs thru the hole in the lower control disk (FIG. 18). The control disk actuator block is attached to the control actuation assembly (FIG. 2, FIG. 3). The upper control disk (FIG. 2-8, FIG. 3-11, FIG. 4-3) is attached to the control disk hinge (FIG. 2-9, FIG. 3-12, FIG. 4-4) at the same radius as the hinge is attached to the lower control disk (FIG. 2-7, FIG. 3-10, FIG. 4-2). The upper control disk has a hole thru the center of it to hold the outer diameter of the two control disk bearings (FIG. 2-12, FIG. 3-15, FIG. 4-7).

The control disk bearings are located towards the top and bottom edges of the upper control disk. The control disk bearings are assembled on the top section of the axle from the support arm disks so that the upper and lower control disks can rotate freely from the support arm disks.

The directional arm (FIG. 1-11, FIG. 2-13, FIG. 3-16, FIG. 17-1) is attached to the top of the upper control disk starting at the control disk bearing and extending outward past the radius of the upper control disk and located at a ninety degrees clockwise rotation from where the control disk hinge is below (FIG. 17). At the outward end of the directional arm is attached the directional fin (FIG. 1-13, FIG. 3-17, FIG. 17-2). The directional fin is a thin flat triangular part with one edge attached to the directional arm and the other two edges extending upwards from the directional arm.

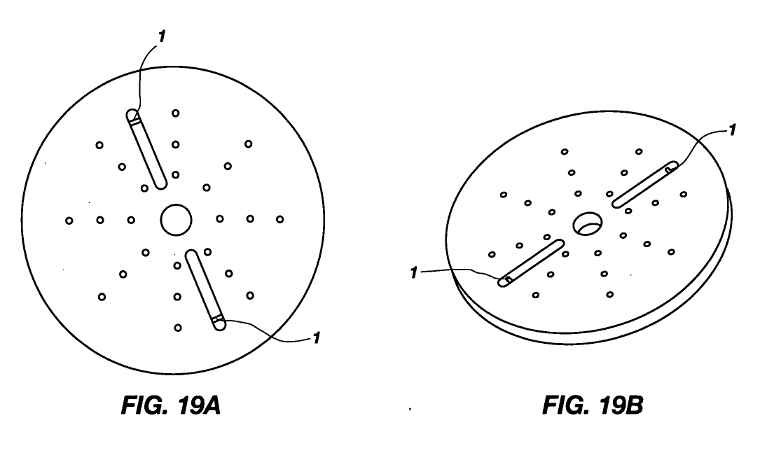

The control actuation assembly (FIG. 2, FIG. 3) is comprised of two counter weights (FIG. 2-14, FIG. 3-20, FIG. 17-3), two counter weight arms (FIG. 2-15, FIG. 3-21), two counter weight arm links (FIG. 2-16, FIG. 3-22, FIG. 4-8), a slide disk (FIG. 2-17, FIG. 3-23, FIG. 4-7), two lower slide disk tabs (FIG. 3-24) and a slide disk bearing (FIG. 4-9). The counter weight is a block (FIG. 2-14, FIG. 3-20, FIG. 17-3) with a hole thru to hold on to the counter weight arm (FIG. 2-15, FIG. 3-21). The counter weight arms (FIG. 2-15, FIG. 3-21) originate parallel to the axle (FIG. 2-5) and attached to the lower support disk with pins (FIG. 2-18, FIG. 19-1) and extending upwards to midway between the upper support disk and the lower control disk.

The counter weight has a specific size and weight as to make an outward motion generated from a spinning motion from the support disks. The top end of the counter weight arms (FIG. 2-15, FIG. 3-21) are pinned to the counter weight links (FIG. 2-16, FIG. 3-22, FIG. 4-8). The other ends of the counter weight links are attached to the two lower slide disk tabs (FIG. 3-24) with pins. Each slide disk tab is located one hundred and eighty degrees apart from another on the slide disk lower face. The slide disk has a hole centered in it to hold the slide disk bearing. The outer diameter of the slide disk bearing is attached firmly to the slide disk. The inner diameter of the slide disk bearing is fitted around the axle but not so tight as to allow a sliding action up and down along the axle. The slide disk outer diameter (FIG. 3-23) is fitted into the “u” shaped slot in the lower control disk actuator block (FIG. 3-14) providing rotational movement freely but following the up and down movement of the slide disk.

In operation the wind will push past the support framework and locate the directional arm away from the wind. The vanes on one side of the rotor assembly will be completely opened while on the other side of the rotor the vanes will be closed. There will be torque produced by the wind resistance being different on the opposing sides. This torque will result in a turning motion in the rotor and the preceding support arm and vane assembly will start to open and the receding arm and vane assembly will start to close. This continuing turning action will act on the driveshaft to produce torque and power from the wind. As the wind speed increases the counter weights will move outward and push the slide disk upwards thru the control actuation assembly. As the slide disk moves upwards it will move the lower control disk up with the control disk hinge and change the distance that the slide rods move up and down. This action will regulate the distance that the vanes open and close thru the vane actuation assembly. The distance the vanes open and close will regulate the wind resistance provided by the opened vanes of the rotor and thereby regulate the rotational speed in which the rotor turns to limit the maximum speed to prevent over speed in high wind situations. As more torque is required, the rotor will slow down and the entire system will open up the vanes on the open side (power generation arc) to provide more torque. This system will provide a self regulating speed and torque wind power system.

What is claimed is:

1. A windmill with horizontally oriented blades comprising:
blades formed by a pair of elongated vanes each having a substantially straight edge located proximate to one another;
hinge means interconnecting said elongated vanes along their respective straight edges;
a vertical driveshaft to which said blades are attached and supported; and
control means located along the vertical axis of said vertical driveshaft and interconnected to said vanes to control the degree of opening between a pair of said vanes.

2. The windmill of claim 1, wherein said vanes are of substantially the same dimensions and have an elongated length substantially greater than their width.

3. The windmill of claim 2, wherein said vanes have a concave inner surface which forms a cup-shaped sail area to be acted upon by the wind.

4. The windmill of claim 3, wherein said vanes have an external convex surface which form an airfoil when a pair of vanes close together during rotation of a blade into the wind.

5. In a windmill having horizontally oriented blades and a vertical driveshaft the improvement comprising:
a mechanical regulation mechanism connected to said vertical driveshaft and interconnected to said blades to regulate (control) the sail area of said blades presented to the wind to induce torque upon the driveshaft.

6. The windmill of claim 5, wherein the blades comprise a pair of elongated vanes hinged together along one elongated edge.

7. The windmill of claim 5, wherein the elongated vanes are laterally concave on their inner surface and laterally convex on their outer surface.

8. A windmill having horizontally rotating blades rotating about a vertical driveshaft wherein:
said horizontally rotating blades are formed of a pair of elongated solid blades hinged along an elongated edge of each blade to present said vanes in a closed position and an open position and each blade having a lateral, concave surface.

9. The windmill of claim 1, wherein said vanes are structured to present their concave surfaces to the wind as propulsion sail area and to be in a closed position when said blades are rotating into the wind.

10. The mechanical regulation mechanism of claim 5, wherein said mechanism includes an elongated, weighted pendulum attached directly or indirectly to said vertical driveshaft wherein said pendulum is attached near its upper extremity with its free end free to swing outward upon rotation of the driveshaft and wherein connecting means connects said pendulum to means to adjust the opening between a pair of vanes of a blade.

11. A windmill with horizontally oriented blades comprising:
blades formed by a pair of elongated vanes each having a substantially straight edge located proximate to one another;
hinge means interconnecting said elongated vanes along their respective straight edges;
a vertical driveshaft to which said blades are attached and supported; and
hinge control means interconnected to said vanes to control the degree of opening between a pair of said vanes.

12. The windmill of claim 11, wherein said vanes are of substantially the same dimensions and have an elongated length substantially greater than their width.
